(19) United States
(12) Patent Application Publication
(10) Pub. No.: US 2012/0281714 A1
(43) Pub. Date: Nov. 8, 2012

(54) PACKET PROCESSING ACCELERATOR AND METHOD THEREOF

(75) Inventors: Shang Pin Chang, Hsinchu County (TW); Kuo Yen Fan, Hsinchu County (TW); Chung Chi Lo, Hsinchu County (TW); Shuenn Ren Liu, Hsinchu County (TW)

(73) Assignee: RALINK TECHNOLOGY CORPORATION, Hsinchu County (TW)

(21) Appl. No.: 13/227,927

(22) Filed: Sep. 8, 2011

(30) Foreign Application Priority Data
May 6, 2011 (TW) 100115889

(51) Int. Cl. H04J 99/00

(52) U.S. Cl. 370/465

(57) ABSTRACT

A packet processing accelerator comprises a programmable packet classification module, a programmable flow control module, and a programmable packet header modification module. The programmable packet classification module is configured to receive a data packet and generate a start location of each protocol header of the data packet and a first index. The first index indicates classification of the data packet. The programmable flow control module is configured to generate a code of an output port and an action code according to the start location of each protocol header of the data packet and the first index. The programmable packet header modification module is configured to modify content of a plurality of protocol headers of the data packet according to the action code and to send the modified data packet to an output port according to the code of the output port.

### BACKGROUND OF THE INVENTION

1. Field of the Invention

The present invention relates to a packet processing accelerating method and a device thereof.

2. Description of the Related Art

FIG. 1 is a schematic block diagram illustrating a data packet processing system 10 in the prior art. Referring to FIG. 1, the system 10 includes a multi-port switch fabric 12 that enables a data packet to be transferred among network workstations 14. Each typical network workstation 14 such as a client workstation may send or receive packets at 10 Mbps or 100 Mbps in accordance with Institute of Electrical and Electronics Engineers (IEEE) 802.3 communication protocol. The switch fabric 12 includes multiple Media Access Control (MAC) modules 122. The MAC modules 122 send data packets to the corresponding network workstations 14 and receive data packets from the corresponding network workstations 14 through a 10 Mbps/100 Mbps PHY transceiver (not shown) under the IEEE 802.3 communication protocol.

The system 10 further includes a Direct Memory Access (DMA) controller 16. The DMA controller 16 is responsible for writing the data packets from the switch fabric 12 to an input queue (not shown) of a system memory via a bus 18, and sending the packets in an output queue (not shown) of the system memory to the corresponding network workstations 14.

In the conventional architecture, the packet processing speed is limited by the access speed of the DMA controller 16, and the switch fabric 12 is limited accordingly. Therefore, there is a need to provide a packet accelerator that identifies whether a data packet has a particular structure and determines whether to accelerate the pass of the data packet, thereby increasing a transfer volume of data packets. The packet accelerator is operable to classify the data packets, modify the content of the protocol headers of the data packets after classification by means of a proper flow control, and send the modified data packets to an output port.

### SUMMARY OF THE INVENTION

The present invention is directed to a packet processing accelerator. In an embodiment of the present invention, the packet processing accelerator includes a programmable packet classification module, a programmable flow control module, and a programmable packet header modification module. The programmable packet classification module is configured to receive a data packet and generate a start location of each protocol header of the data packet and a first index, in which the first index indicates classification of the data packet. The programmable flow control module is configured to generate a code of an output port and an action code of the data packet according to the start location of each protocol header of the data packet and the first index. The programmable packet header modification module is configured to modify content of the protocol headers of the data packet according to the action code and to send the modified data packet to an output port according to the code of the output port.

The present invention is also directed to a packet processing accelerating method. In an embodiment of the present invention, the packet processing accelerating method includes: receiving a data packet; generating a start location of each protocol header of the data packet and a first index, in which the first index indicates a classification of the data packet; generating a code of an output port and an action code of the data packet according to the start location of each protocol header of the data packet and the first index; and modifying content of the protocol headers of the data packet according to the action code and sending the modified data packet to an output port according to the code of the output port.

### BRIEF DESCRIPTION OF THE DRAWINGS

The invention will be described according to the appended drawings in which:

FIG. 1 is a schematic block diagram illustrating a conventional data packet processing system;

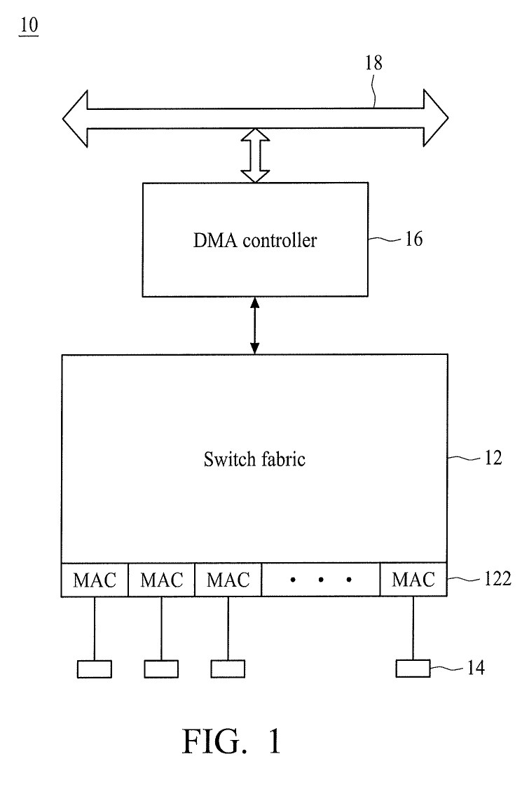

FIG. 2 illustrates a packet processing accelerator according to an embodiment of the present invention;

FIG. 3 is a flow chart of a packet processing accelerating method according to an embodiment of the present invention;

FIG. 4 is a schematic block diagram illustrating a programmable packet classification module according to an embodiment of the present invention;

FIG. 5 is a schematic structural view illustrating a data packet having protocol headers and a payload according to an embodiment of the present invention;

FIG. 6 is a schematic structural view illustrating a plurality of typical network packets;

FIG. 7 illustrates comparison results of a packet parsing unit according to an embodiment of the present invention;

FIG. 8 is a schematic block diagram illustrating a programmable flow control module according to an embodiment of the present invention;

FIG. 9 illustrates tuples extracted by a tuple-generating unit according to an embodiment of the present invention;

FIG. 10 is a schematic block diagram illustrating a search unit according to an embodiment of the present invention;

FIG. 11 illustrates data formats of a hash table and a comparison table according to an embodiment of the present invention;

FIG. 12 illustrates a data format of a flow table according to an embodiment of the present invention;

FIG. 13 is a schematic block diagram illustrating a programmable packet header modification module according to an embodiment of the present invention;

FIG. 14 illustrates data formats of a macro table, a vector table, and an operation table according to an embodiment of the present invention; and

FIG. 15 is a schematic block diagram illustrating a data packet processing system according to an embodiment of the present invention.

### PREFERRED EMBODIMENT OF THE PRESENT INVENTION

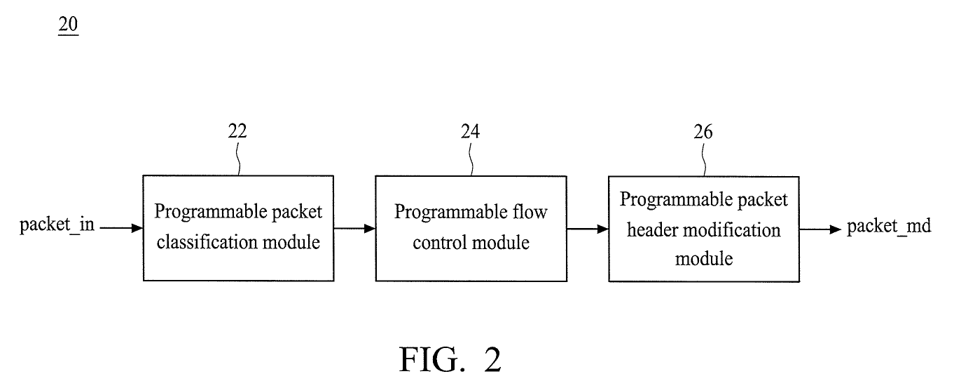

To more clearly explain a packet processing accelerating method of the present invention, the circuit architecture for executing the method of the present invention is described as follows. FIG. 2 illustrates a packet processing accelerator 20 according to an embodiment of the present invention. Referring to FIG. 2, the packet processing accelerator 20 includes a programmable packet classification module 22, a programmable flow control module 24, and a programmable packet header modification module 26. The programmable packet classification module 22 is configured to receive a data packet packet_in and generate a start location of protocol headers of the data packet packet_in and an index that indicates different packet types. The programmable flow control module 24 is configured to generate a code of an output port and an action code of the data packet packet_in according to an output result of the programmable packet classification module 22. The programmable packet header modification module 26 is configured to modify content of the protocol headers of the data packet packet_in according to the action code, and to send the modified data packet packet_md to an output port according to the code of the output port.

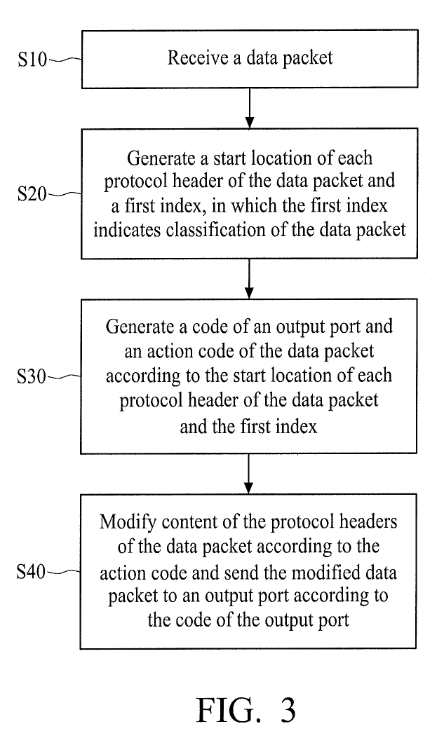

FIG. 3 is a flow chart of a packet processing accelerating method according to an embodiment of the present invention. The method comprises: receiving a data packet (step S10); generating a start location of each protocol header of the data packet and a first index, in which the first index indicates classification of the data packet (step S20); generating a code of an output port and an action code of the data packet according to the start location of each protocol header of the data packet and the first index (step S30); and modifying content of the protocol headers of the data packet according to the action code and sending the modified data packet to an output port according to the code of the output port (step S40). Hereinafter, the packet processing accelerating method of the present invention is described in detail with reference to FIG. 2 and FIGS. 4 to 15.

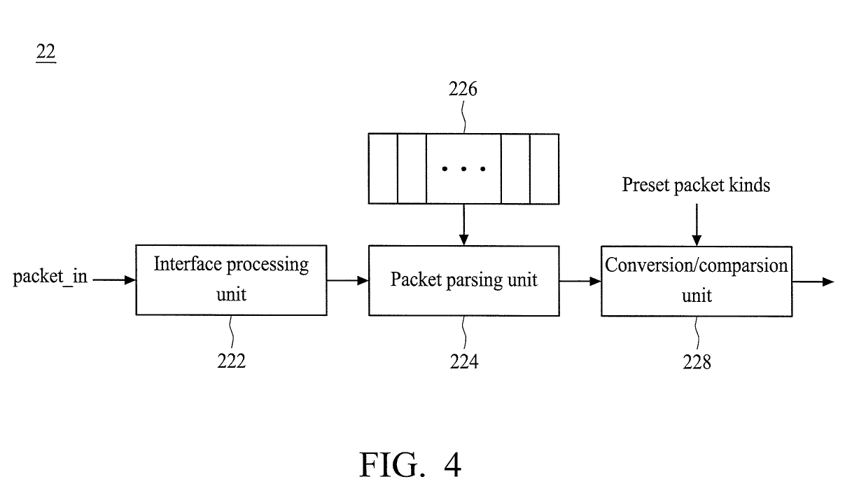

Referring to FIG. 2, a data packet packet_in is input to the programmable packet classification module 22. FIG. 4 is a schematic block diagram illustrating a programmable packet classification module 22 according to an embodiment of the present invention. Referring to FIG. 4, the programmable packet classification module 22 includes an interface processing unit 222, a packet parsing unit 224, a plurality of preset fields 226, and a conversion/comparison unit 228. The interface processing unit 222 identifies a parsed start location of the protocol header according to an input port of the packet after receiving the input data packet packet_in.

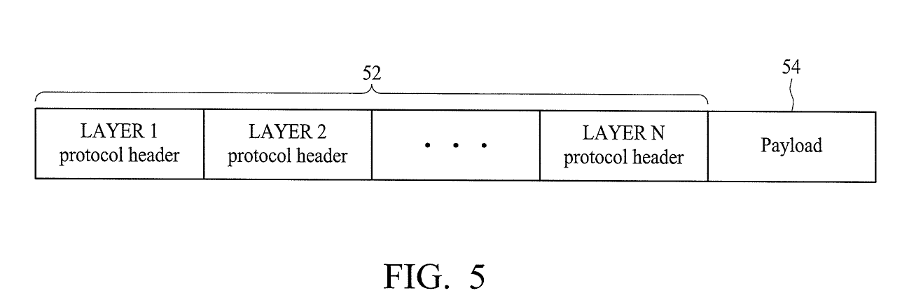

FIG. 5 is a schematic structural view illustrating a data packet packet_in having protocol headers 52 and a payload 54 according to an embodiment of the present invention. The data packet packet_in has a multi-layer data structure. Referring to FIG. 5, the data packet packet_in starts with the protocol header of a layer 1, where the protocol header of the layer 1 is followed by the protocol header of a layer 2 and the protocol header of a layer 3. The protocol header of a layer n is followed by a payload 54 that records data of the packet.

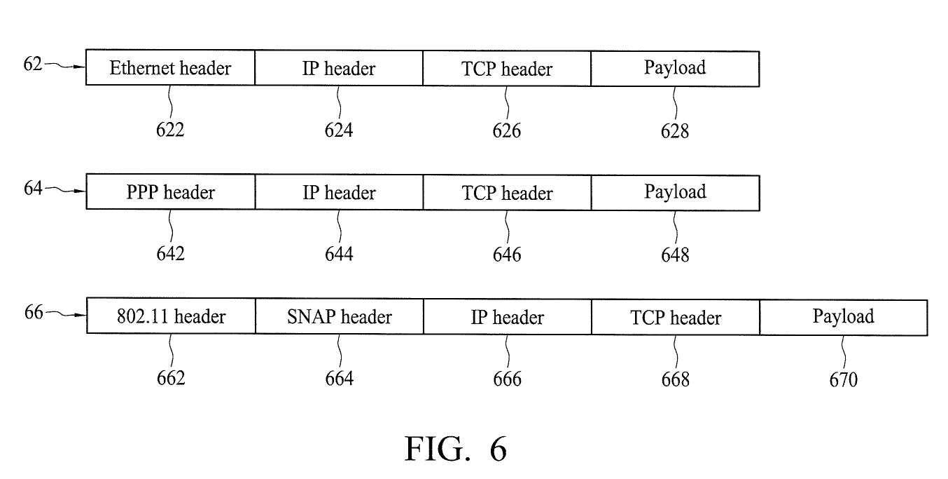

FIG. 6 is a schematic structural view illustrating a plurality of typical network packets. The packet 62 in FIG. 6 is an Ethernet packet, and includes an Ethernet header 622, an Internet Protocol (IP) header 624, a Transmission Control Protocol (TCP) header 626, and a payload 628. The packet 64 in FIG. 6 is a Point-to-Point Protocol (PPP) packet, which is commonly used in a Packet over Synchronous Optical Network (SONET) (PoS) network link. The packet 64 includes a PPP header 642, an IP header 644, a TCP header 646, and a payload 648. The packet 66 in FIG. 6 is a wireless packet including an 802.11 header 662, a Subnetwork Access Protocol (SNAP) header 664, an IP header 666, a TCP header 668, and a payload 670. Referring to FIG. 6, the packet 32, the packet 34, and the packet 36 have the same protocol header in some particular low-level ft) protocols, and other headers are established on different low-level protocols. Therefore, the interface processing unit 222 in FIG. 2 may identify the start location parsed from the data packet packet_in according to different packet types from different input ports after receiving the input data packet packet_in.

For example, if the input data packet packet_in is the Ethernet packet in FIG. 6, the data packet packet_in starts parsing from the Ethernet header 622 according to a table built in the interface processing unit 222. If the input data packet packet_in is the wireless packet in FIG. 6, the data packet packet_in starts parsing from the 802.11 header 662 according to the table built in the interface processing unit 222.

After the start location of the parsed protocol header is determined, the packet parsing unit 224 is configured to output a plurality of entries to the conversion/comparison unit 228, in which the entries are the comparison results obtained between the content of a plurality of protocol headers of the data packet packet_in in layer 2 to layer 4 and the plurality of preset fields. According to the Open System Interface (OSI) architecture of an International Organization for Standardization (ISO), the OSI layer 2 is a data link layer, which is configured to send frames and detect errors. The typical data link layer protocol includes Point-to-Point Protocol (PPP), Systems Network Architecture (SNA), and IEEE 802 family. In some circumstances, the data link lay er may be divided into two sub-layers, namely, a MAC sub-layer and a Logical Link Control (LLC) sub-layer disposed on the MAC sub-layer.

The OSI layer 3 is a network layer and has a main function of routing the packets from a source to a destination with the shortest path. The most common network communication protocol is IP. The protocol is configured to designate and decode an IP address, which can identify the entry coupled to the network. The IP communication protocol has two versions in use, IP Version 4 (IPV4) and IP Version 6 (IPV6).

The OSI layer 4 is a transport layer, which is configured to provide reliable data transfer between two terminals. The transport layer may achieve the reliable data transfer by sorting, error control, and flow generation control. The typical transfer protocol includes a TCP, a User Datagram Protocol (UDP), and an Internet Control Message Protocol (ICMP).

Referring to FIG. 4, in operation, the packet parsing unit 224 compares the content of the protocol headers in the layer 2 to the layer 4 of the data packet packet_in with the plurality of preset fields 226, and outputs comparison results to the conversion/comparison unit 228. In an embodiment of the present invention, the preset fields 226 may include a MAC Source Address (SA), a MAC Destination Address (DA), a Virtual Local Area Network (VLAN) Identifier (ID), and a PortID in the layer 2; IPV4 and IPV6 protocol formats, a SA, and a DA in the layer 3; and a port number in the layer 4. During comparison, if the content of the protocol headers of the data packet packet_in conforms to the content of the preset fields 226, the packet parsing unit 224 outputs a bit “1” entry to the conversion/comparison unit 228. Alternatively, if the content of the protocol headers of the data packet packet_in does not conform to the content of the preset fields 226, the packet parsing unit 224 outputs a bit “0” entry to the conversion/comparison unit 228. Moreover, the packet parsing unit 224 after comparison may determine the start location of the protocol headers in layer 2 to layer 4 of the data packet packet_in. Therefore, the information related to the start location of the protocol headers in layer 2 to layer 4 is output to the conversion/comparison unit 228 and the next-level programmable flow control module 24.

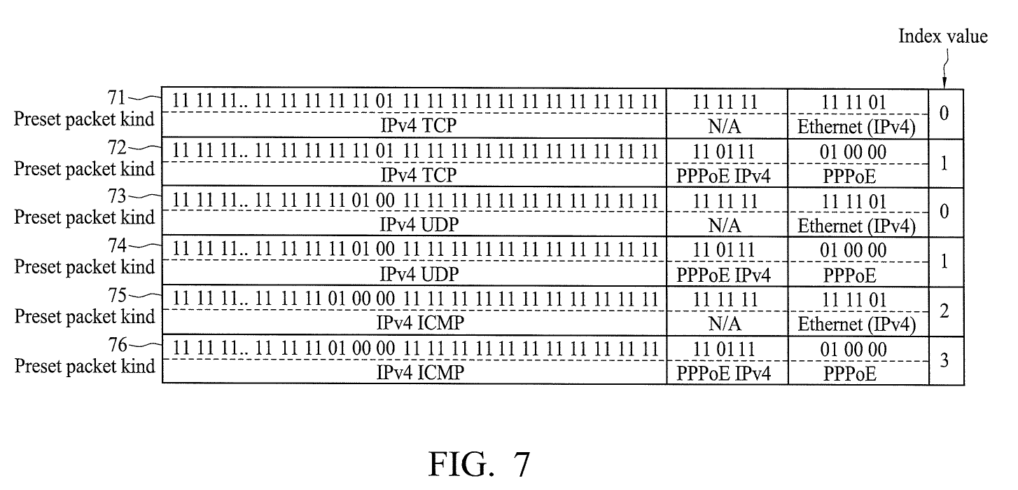

Referring to FIG. 4, after receiving the entries output by the packet parsing unit 224, the conversion/comparison unit 228 compares the entries with the plurality of preset packet types, and generates an index. FIG. 7 illustrates comparison results of the packet parsing unit 224 according to an embodiment of the present invention. Referring to FIG. 7, multiple data packets packet_in after being parsed by the packet parsing unit 224 to generate the plurality of entries 71, 72, 73, 74, 75, and 76. Each of the plurality of entries is compared with multiple preset packet types, and indices 0 to 5 are generated. In this embodiment, the entry 71 is divided into three sections. In the first section, entry 71 conforms to the IPv4/TCP protocol format; in the second section, entry 71 does not conform to the PPP over Ethernet (PPPoE)/IPV4 protocol format; and in the third section, entry 71 conforms to the Ethernet/IPv4 protocol format. Therefore, after comparison, entry 71 is indicated by an index 0.

Moreover, the conversion/comparison unit 228 additionally executes a comparison function. If the input data packet packet_in cannot be classified into the preset index, the input data packet packet_in is determined to be the packet which cannot be subjected to the acceleration process.

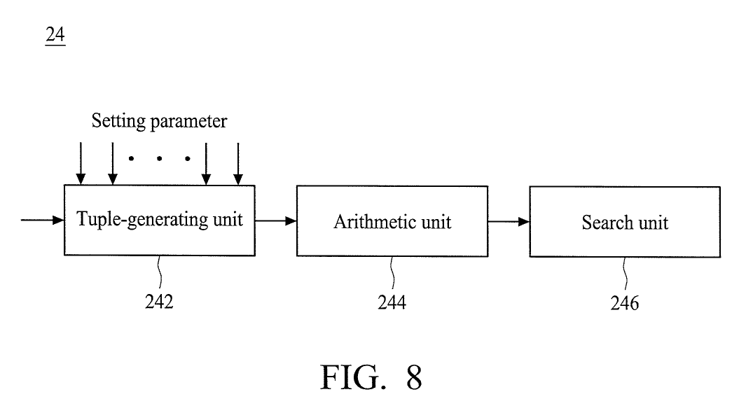

Referring to FIG. 2, after the start location of the protocol headers in layer 2 to layer 4 of the data packet packet_in is determined, the programmable flow control module 24 extracts a tuple from the output result of the programmable packet classification module 22. FIG. 8 is a schematic block diagram illustrating a programmable flow control module 24 according to an embodiment of the present invention. Referring to FIG. 8, the programmable flow control module 24 includes a tuple-generating unit 242, an arithmetic unit 244, and a search unit 246. The tuple-generating unit 242 is configured to generate a plurality of tuples through the index output by the conversion/comparison unit 228 according to the plurality of setting parameters. The arithmetic unit 244 is configured to calculate a hash value of the tuples. The search unit 246 is configured to generate a code of an output port and an action code of the data packet packet_in according to the hash value.

In an embodiment of the present invention, the tuple-generating unit 242 extracts the tuples for the protocol header in the layer 2, layer 3, or layer 4 from the plurality of entries output by the packet parsing unit 224. When extracting the first tuple among the tuples, the tuple-generating unit 242 chooses which layer of the protocol the data packet packet_in starts extraction from according to an lsel parameter. As the tuple-generating unit 242 is configured to obtain information related to the start location of the protocol headers in layer 2 to layer 4 of the data packet packet_in, the tuple-generating unit 242 may choose starting extraction of some bytes of data from one entry after the start location is offset according to an offset parameter and a len parameter.

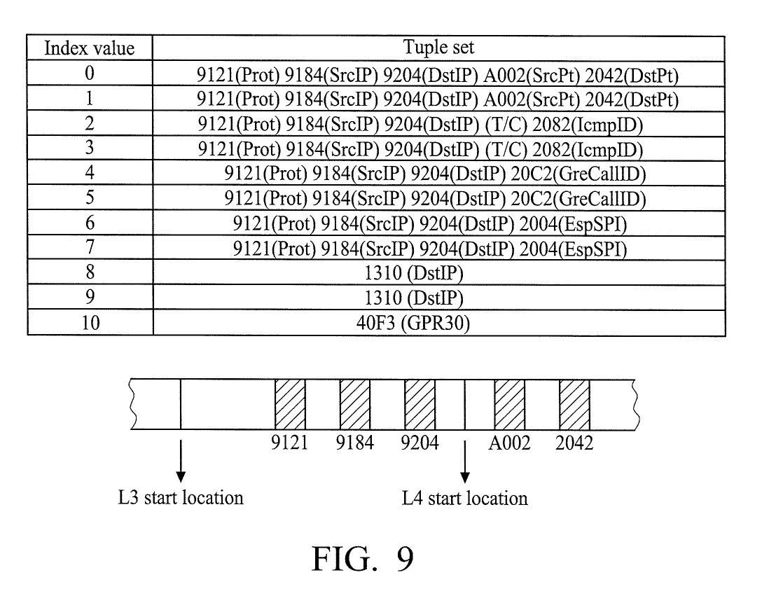

FIG. 9 illustrates tuples extracted by a tuple-generating unit 242 according to an embodiment of the present invention. The index in FIG. 9 is an index output by the conversion/comparison unit 228 at the previous level, in which the indices 0 to 3 indicate that the data packet packet_in is a packet having the TCP/UDPACMP protocol header, and the indices 8 to 9 indicate that the data packet packet_in is a packet having the IPV6 protocol header. The plurality of tuples corresponding to the index 0 are respectively corresponding to an IP SA, an IP DA, an IP protocol type, a source port, a destination port and the like in the entries output by the packet parsing unit 224.

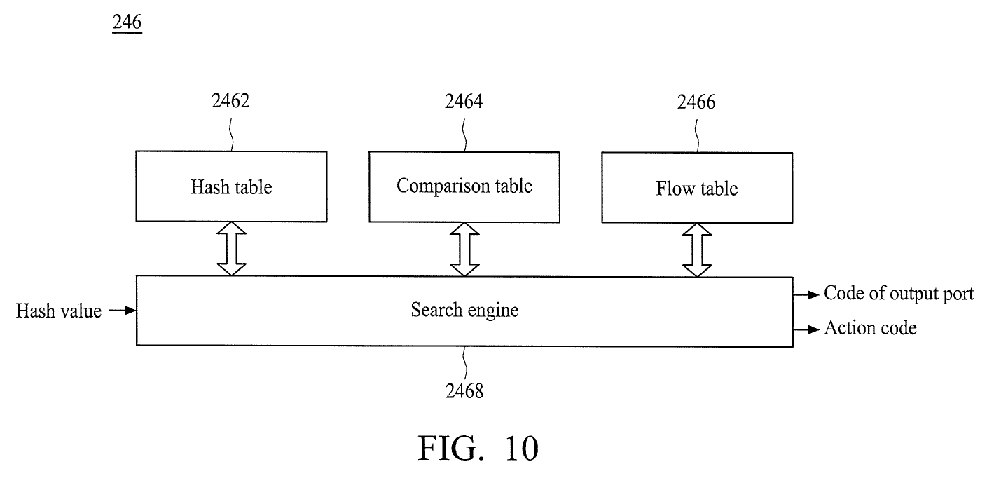

After the plurality of tuples are generated, the arithmetic unit 244 calculates a hash value for the tuples by a 16-bit Cycle Redundancy Check (CRC), and the search unit 246 generates a code of an output port and an action code of the data packet packet_in according to the hash value. FIG. 10 is a schematic block diagram illustrating a search unit 246 according to an embodiment of the present invention. Referring to FIG. 10, the search unit 246 includes a hash table 2462, a comparison table 2464, a flow table 2466, and a search engine 2468. The search engine 2468 is configured to search a code of an output port and an action code generated by a hash value according to the content of the hash table 2462, the comparison table 2464, and the flow table 2466.

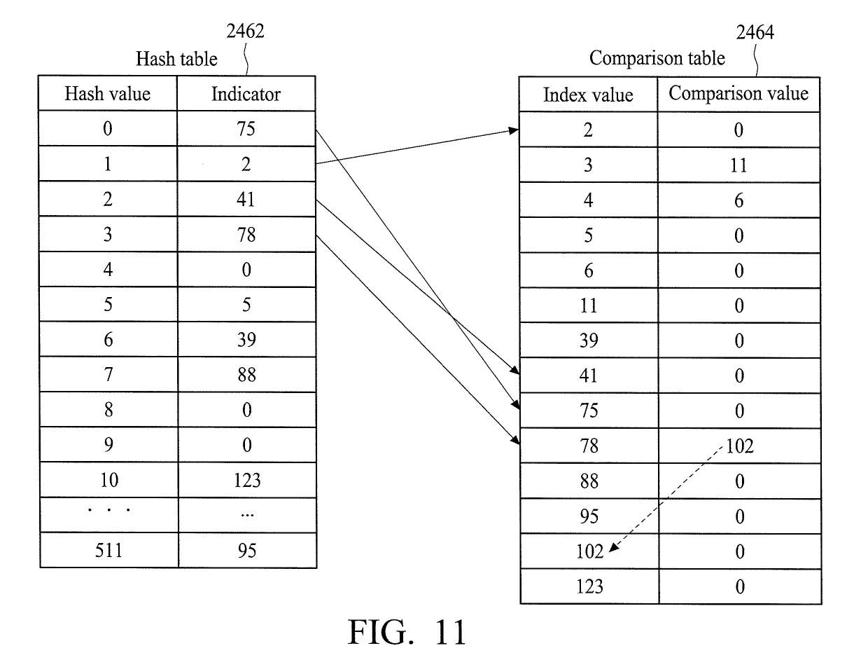

FIG. 11 illustrates data formats of a hash table 2462 and a comparison table 2464 according to an embodiment of the present invention. Referring to FIG. 11, the hash value calculated by the arithmetic unit 244 serves as the index of the hash table 2462, and the hash table 2462 is piloted to a comparison table 2464 having multiple entries. The hash table 2462 includes a plurality of hash values and a plurality of indicators. Each indicator corresponds to a hash value. The comparison table 2464 includes a plurality of indices corresponding to the indicators of the hash table and a plurality of comparison values. Each comparison value is linked to the field in the table that indicates the next entry. For example, in this embodiment, the indicator 75 indicates the index 75 in the comparison table 2464. As the comparison value corresponding to the index 75 is 0, the index 75 of the comparison table 2464 is the final output index. On the other hand, the indicator 78 indicates an index 78 of the comparison table 2464. As the comparison value corresponding to the index 78 is 102 and the comparison value corresponding to the index 102 is 0, the index 102 of the comparison table 2464 is the final output index.

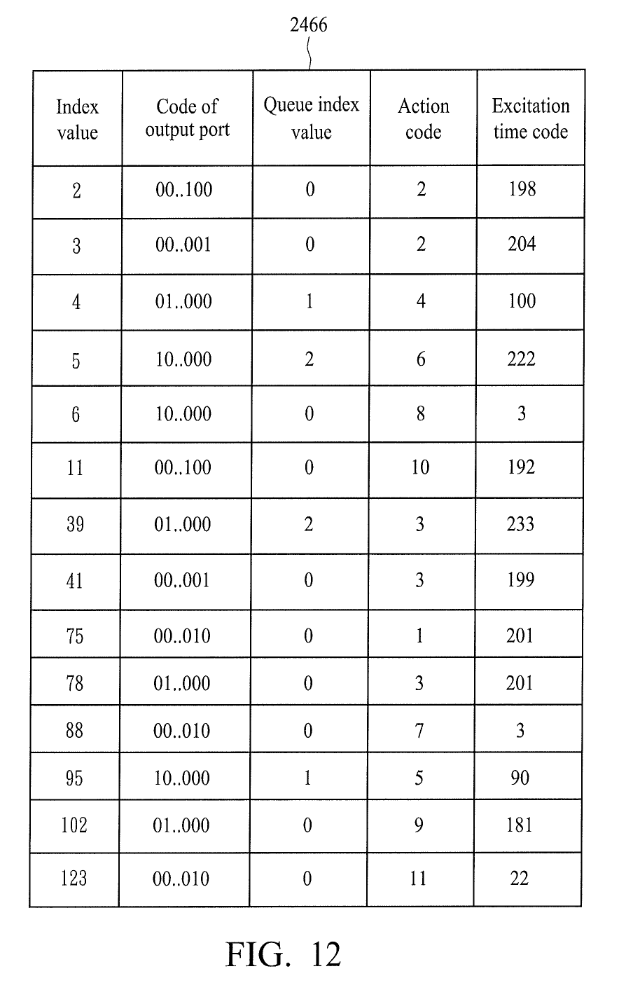

The comparison table 2464 is piloted to a flow table 2466 having multiple indices. FIG. 12 illustrates a data format of a flow table 2466 according to an embodiment of the present invention. As described above, the final index generated by the comparison table 2464 may serve as the index of the flow table 2466. Referring to FIG. 12, the flow table 2466 is formed by a plurality of fields. Each field includes an index, a code of an output port, a queue index, an action code, and an excitation time code. The code of the output port indicates an output interface of the modified packet. The queue index indicates the output queue. The action code indicates the modification aspect of the protocol header of the data packet packet_in. The excitation time code indicates the detected excitation time after the flow stops. The search engine 2468 searches a code of an output port and an action code generated by a particular hash value according to the content of the hash table 2462, the comparison table 2464, and the flow table 2466.

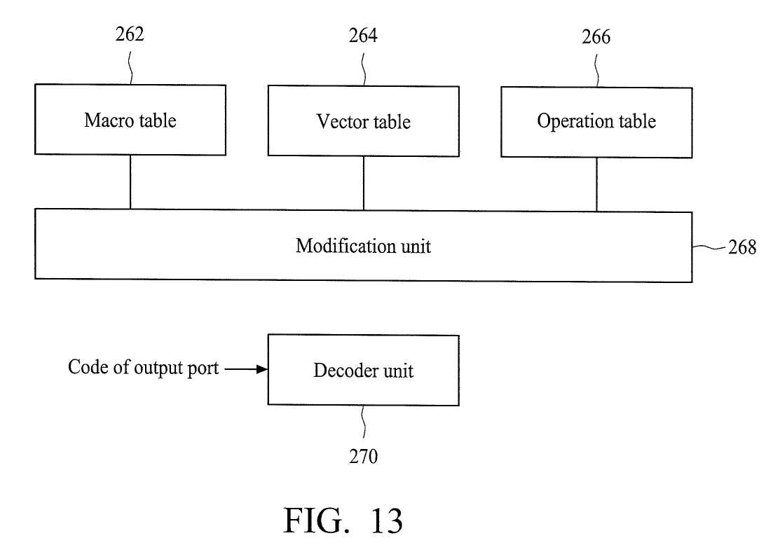

Referring to FIG. 2, after a code of an output port and an action code are generated according to a particular hash value, the programmable packet header modification module 26 receives the data and executes the following steps. FIG. 13 is a schematic block diagram illustrating a programmable packet header modification module 26 according to an embodiment of the present invention. Referring to FIG. 13, the programmable packet header modification module 26 includes a macro table 262, a vector table 264, an operation table 266, a modification unit 268, and a decoder unit 270. The modification unit 268 is configured to modify the protocol headers of the data packet packet_in according to the content of the macro table 262, the vector table 264, and the operation table 266. The decoder unit 270 is configured to decode the code of the output port to obtain the data of the output port of the modified data packet data_md.

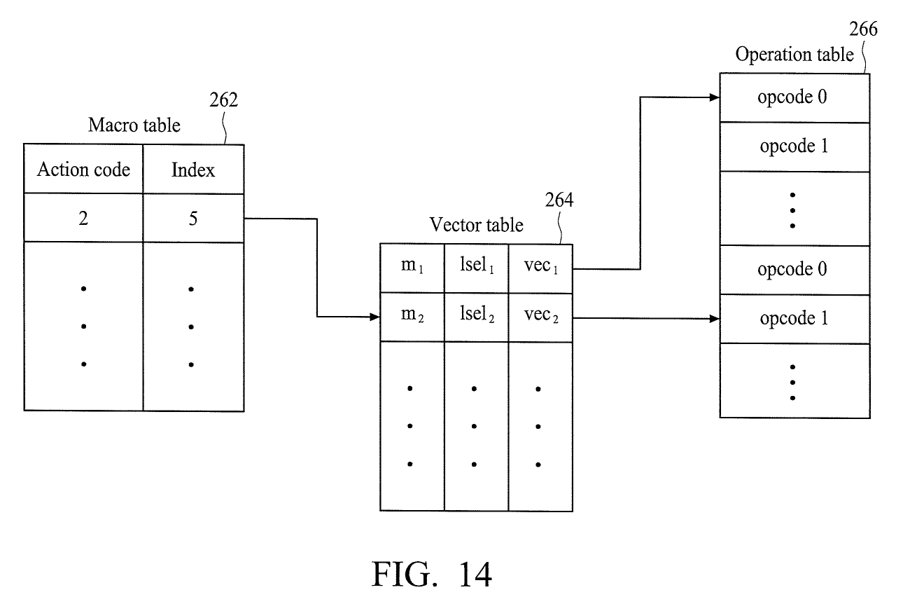

FIG. 14 illustrates data formats of a macro table 262, a vector table 264, and an operation table 266 according to an embodiment of the present invention. Referring to FIG. 14, the macro table 262 includes a plurality of action codes and a plurality of indicators. Each indicator corresponds to an action code. The plurality of action codes of the macro table 262 indicate a Network Address Translation (NAT) function that is executed by the modification unit 268. Table 1 shows the operations indicated by the action codes of the macro table 262.

TABLE 1

| LAYER | OPERATION ACTION |
|---|---|
| Layer 2 | Insert/remove/replace MAC DA |
| | Insert/remove/replace MAC SA |
| | Insert/remove/replace VLAN |
| | Insert/remove PPPoE |
| | Insert/remove particular tag (for Ethernet Switch) |
| | Insert/remove MPOA |
| | 802.1p VLAN QoS tag |
| Layer 3 | Replace source IP |
| | Replace destination IP |
| | Update IP checksum |
| | Update TTL |
| | TOS/DSCP tag |
| Layer 4 | Replace source port |
| | Replace destination port |
| | Replace ICMP ID |
| | Update TCP checksum |
| | Update UDP checksum |
| | Update ICMP checksum |

Referring to FIG. 14, each indicator of the macro table 262 indicates a particular field of the vector table 264. The vector table 264 is formed by a plurality of fields. Each field includes an indicator bit m, a layer selection bit lsel, and a vector vec. The action code of the macro table 262 may designate the protocol layer each time the modification is executed through the layer selection bit lsel. Referring to FIG. 14, each vector vec of the vector table 264 indicates a particular field of the operation table 266. The operation table 266 is formed by a plurality of fields. Each field includes an operation code opcode. The operation code opcode indicates the modification action that the modification unit 268 is conducted to the protocol header of the data packet packet_in, and includes actions like insert, remove, replace, and update.

After the modification unit 268 finishes the modification action of the protocol headers of the data packet packet_in, the modified data packet packet_md is sent to a particular output port through a decoding result of the decoder unit 270.

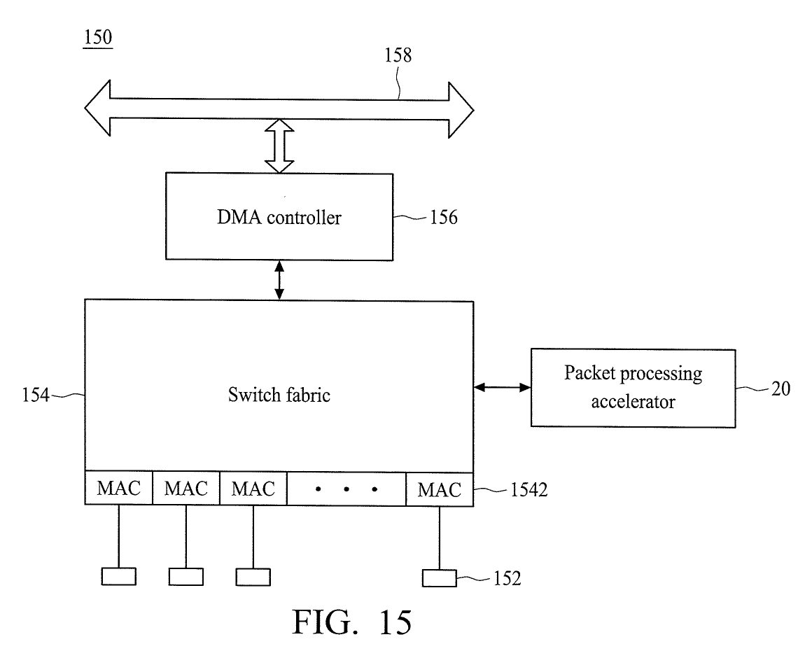

In an embodiment of the present invention, the packet processing accelerator 20 may process the input data packet with a switch fabric. FIG. 15 is a schematic block diagram illustrating a data packet processing system 150 according to an embodiment of the present invention. Referring to FIG. 15, the system 150 includes a multi-port switch fabric 154 for transferring the data packets among network workstations 152. The switch fabric 154 includes a plurality of MAC modules 1542. Each MAC module 1542 sends the data packet to the corresponding network workstation 152 through a PHY transceiver (not shown) that conforms to a particular communication protocol, and receives the data packet from the corresponding network workstation 152.

After receiving the data packet, the switch fabric 154 sends the data packet to the packet processing accelerator 20. The packet processing accelerator 20 determines whether the entered data packet is the packet suitable for the accelerating process. If the data packet is not suitable for the accelerating process, the data packet is sent to a DMA controller 156, so as to be sent to another processing device for the follow-up process via a bus 158. Alternatively, if the data packet is suitable for the accelerating process, the data packet is sent to the packet processing accelerator 20 for the packet classification, flow control, and modification conducted by the programmable packet classification module 22, the programmable flow control module 24, and the programmable packet header modification module 26. The device and method of the present invention may greatly improve the transfer volume of the data packets.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in to the art from this detailed description.

What is claimed is:

1. A packet processing accelerator, comprising:
a programmable packet classification module, configured to receive a data packet and generate a start location of each protocol header of the data packet and a first index, wherein the first index indicates classification of the data packet;
a programmable flow control module, configured to generate a code of an output port and an action code of the data packet according to the start location of each protocol header of the data packet and the first index; and
a programmable packet header modification module, configured to modify content of a plurality of protocol headers of the data packet according to the action code and to send the modified data packet to an output port according to the code of the output port.

2. The packet processing accelerator according to claim 1, wherein the programmable packet classification module comprises:
an interface processing unit, configured to identify a start location of the parsed protocol header of the data packet according to an input port of the data packet;
a plurality of preset fields;
a packet parsing unit, configured to output a plurality of entries according to the start location of the parsed protocol header of the data packet, wherein the entries are comparison results obtained between the content of a plurality of protocol headers of the data packet and the preset fields; and
a conversion/comparison unit, configured to compare the entries with the plurality of preset packet types and generate the first index after receiving the entries.

3. The packet processing accelerator according to claim 2, wherein the preset fields comprise a Media Access Control (MAC) Source Address (SA), a MAC Destination Address (DA), a Virtual Local Area Network (VLAN) Identifier (ID), and a PortID in the Open Systems Interconnection (OSI) layer 2.

4. The packet processing accelerator according to claim 2, wherein the preset fields comprise an Internet Protocol Version 4 (IPV4) protocol format, an Internet Protocol Version 6 (IPV6) protocol format, a SA, and a DA in the OSI layer 3.

5. The packet processing accelerator according to claim 1, wherein the programmable flow control module comprises:
a tuple-generating unit, configured to generate a plurality of tuples from the first index according to a plurality of setting parameters;
an arithmetic unit, configured to calculate a hash value of the tuples; and
a search unit, configured to generate the code of the output port and the action code of the data packet according to the hash value.

6. The packet processing accelerator according to claim 5, wherein the setting parameters comprise the start location of each protocol header of the data packet, assigned layer data, offset data, and sample bit data.

7. The packet processing accelerator according to claim 5, wherein the search unit comprises:
a hash table, comprising a plurality of hash values and a plurality of indicators, wherein each indicator corresponds to a hash value;
a comparison table, comprising a plurality of second indices corresponding to the indicators of the hash table and a plurality of comparison values, wherein each comparison value corresponds to one of the second indices and the comparison value is configured to indicate a next index;
a flow table, comprising a third index and the code of the output port and the action code corresponding to the third index, wherein the third index is the second index or the next index in the comparison table; and
a search engine, configured to search the code of the output port and the action code generated from the hash value according to the content of the hash table, the comparison table, and the flow table.

8. The packet processing accelerator according to claim 1, wherein the programmable packet header modification module comprises:
a macro table, comprising a plurality of action codes and a plurality of indicators, wherein each indicator corresponds to an action code and each indicator indicates a field of a vector table;
a vector table, formed by a plurality of fields, wherein each field comprises an indicator bit, a layer selection bit, and a vector, wherein each vector indicates a field of an operation table;
an operation table, formed by a plurality of fields, wherein each field comprises an operation code;
a modification unit, configured to modify the protocol headers of the data packet according to the content of the macro table, the vector table, and the operation table; and
a decoder unit, configured to decode the code of the output port to obtain data of the output port.

9. A packet processing accelerating method, comprising:
receiving a data packet;
generating a start location of each protocol header of the data packet and a first index, wherein the first index indicates classification of the data packet;
generating a code of an output port and an action code of the data packet according to the start location of each protocol header of the data packet and the first index; and
modifying content of the protocol headers of the data packet according to the action code and sending the modified data packet to an output port according to the code of the output port.

10. The packet processing accelerating method according to claim 9, wherein the step of generating the start location of each protocol header of the data packet and the first index comprises:
identifying a start location of the parsed protocol header of the data packet according to an input port of the data packet;
comparing the content of the protocol headers of the data packet with a plurality of preset fields according to the start location of the parsed protocol header of the data packet;
outputting a plurality of entries according to comparison results; and
comparing the entries with the plurality of preset packet types and generating the first index.

11. The packet processing accelerating method according to claim 10, wherein the preset fields comprise a Media Access Control (MAC) Source Address (SA), a MAC Destination Address (DA), a Virtual Local Area Network (VLAN) Identifier (ID) and a PortID in the Open Systems Interconnection (OSI) layer 2.

12. The packet processing accelerating method according to claim 10, wherein the preset fields comprise an Internet Protocol Version 4 (IPV4) protocol format, an Internet Protocol Version 6 (IPV6) protocol format, a SA, and a DA in the OSI layer 3.

13. The packet processing accelerating method according to claim 10, wherein the step of generating the code of the output port and the action code of the data packet comprises:
generating a plurality of tuples from the first index according to a plurality of setting parameters;
calculating a hash value of the tuples; and
generating the code of the output port and the action code of the data packet according to the hash value.

14. The packet processing accelerating method according to claim 13, wherein the setting parameters comprise a start location of each protocol header of the data packet, assigned layer data, offset data, and sample bit data.

15. The packet processing accelerating method according to claim 13, wherein the step of generating the code of the output port and the action code of the data packet according to the hash value comprises:
searching the code of the output port and the action code generated from the hash value according to content of a hash table, a comparison table, and a flow table;
wherein the hash table comprises a plurality of hash values and a plurality of indicators, and each indicator corresponds to a hash value;
wherein the comparison table comprises a plurality of second indices corresponding to the indicators of the hash table and a plurality of comparison values, each comparison value corresponds to one of the second indices, and the comparison value is configured to indicate a next index;
wherein the flow table comprises a third index and the code of the output port and the action code correspond to the third index, and the third index is the second index or the next index in the comparison table.

16. The packet processing accelerating method according to claim 9, wherein the step of modifying the content of the protocol headers of the data packet according to the action code and sending the modified data packet to the output port according to the code of the output port comprises:
modifying the protocol headers of the data packet according to content of a macro table, a vector table and an operation table; and
decoding the code of the output port to obtain data of the output port;
wherein the macro table comprises a plurality of action codes and a plurality of indicators, each indicator corresponds to an action code, and each indicator indicates a field of the vector table;
wherein the vector table is formed by a plurality of fields, each field comprises an indicator bit, a layer selection bit, and a vector, and each vector indicates a field of the operation table;
wherein the operation table is formed by a plurality of fields, and each field comprises an operation code.
